(19) United States
(12) Patent Application Publication
(10) Pub. No.: US 2025/0389584 A1
(43) Pub. Date: Dec. 25, 2025

(54) SPECTROSCOPIC ANALYSIS APPARATUS, SPECTROSCOPIC ANALYSIS METHOD, AND SPECTROSCOPIC ANALYSIS PROGRAM

(71) Applicants: HITACHI HIGH-TECH ANALYSIS CORPORATION, Tokyo (JP); Hitachi High-Tech Corporation, Tokyo (JP)

(72) Inventors: Kai MARUYAMA, Tokyo (JP); Yoshimitsu OJIMA, Tokyo (JP); Yuka IWAYA, Tokyo (JP); Hiroyuki WADA, Tokyo (JP); Jun HORIGOME, Tokyo (JP)

(21) Appl. No.: 19/246,378

(22) Filed: Jun. 23, 2025

(30) Foreign Application Priority Data
Jun. 24, 2024 (JP) 2024-101352

(51) Int. Cl. G01J 3/427; G01J 3/02; G01J 3/28

(52) U.S. Cl. CPC G01J 3/427; G01J 3/0286; G01J 3/0297; G01J 2003/2836

(57) ABSTRACT

The spectroscopic analysis apparatus (1) includes a light source (11) configured to emit light comprising at least a first wavelength and a second wavelength, a spectrometer (12) configured to separate the light emitted from the light source (11) into light of the first wavelength and light of the second wavelength, a detector (14) configured to detect light of the first wavelength and light of the second wavelength that are emitted from the spectrometer (12) and pass through a sample(S), and a controller (16) configured to calculate first absorbance of the sample corresponding to light of the first wavelength and second absorbance of the sample corresponding to light of the second wavelength on the basis of a detection result of the detector (14), wherein the controller (16) calculates post-correction absorbance of the sample(S) corresponding to light of the first wavelength by correcting the first absorbance using the second absorbance.

### CROSS REFERENCE TO RELATED APPLICATION

The present application claims priority to Japanese Patent Application No. JP2024-101232, filed Jun. 24, 2024, the entire contents of which are incorporated herein for all purposes by this reference.

### BACKGROUND

### Technical Field

The present disclosure relates to a spectroscopic analysis apparatus, a spectroscopic analysis method, and a spectroscopic analysis program.

### Description of the Related Art

A spectrophotometer, such as an analytical fluorescence spectrophotometer, is a device that acquires the incident light amount on a sample that is a measurement object in advance, and obtains a measurement value by converting the reduction in the incident light amount into transmittance or absorbance.

The zero point (origin) of the incident light amount in the measurement of spectroscopic analysis apparatuses can vary due to various factors. As the factors causing the variation, there are changes in the characteristics of the apparatuses including changes in the energy of a light source, variations in the optical path of an optical system (such as thermal expansion and contraction of the optical system due to temperature), changes in the characteristics of optical elements such as mirrors and lenses, and changes in the detection efficiency of a detector. Further, variations in the environment around the apparatuses are also included in the factors. As the operation of the spectroscopic analysis apparatus continues for a long period, the variation of the zero point has a significant impact on measurement, so it is necessary to regularly perform zero point calibration.

### PRIOR ART DOCUMENT

### Patent Document

[Patent Document 1] Japanese Patent Application Publication No. 1998-104215
[Patent Document 2] Japanese Patent Application Publication No. 2019-020362
[Patent Document 3] Japanese Patent Application Publication No. 2016-161455

### SUMMARY

Zero point calibration is typically performed by measuring a reference sample, such as a solvent (so-called blank solution) or a standard sample adjusted to a specified concentration, while replacing a sample that is measurement object, and using the measurement result of the reference sample to perform the zero point calibration. However, when it is required to continuously measure a measurement sample, such as monitoring the measurement sample over a long period of time, it may not be possible to replace the measurement sample with a reference sample for measurement in some cases.

Further, there is also a double-beam apparatus that performs measurement not only on a measurement object sample but also concurrently on the reference sample. However, such apparatuses typically have asymmetric optical paths, along which light passes through a sample that is a measurement object sample and a reference sample, and when measurement extends over a long time, misalignment between the two optical paths may become significant and it may be difficult to perform accurate measurement.

The present disclosure relates to a spectroscopic analysis apparatus, a spectroscopic analysis method, and a spectroscopic analysis program, which enable stable measurement by correcting the drift of a zero point without the need to replace blank solutions, reference samples, etc., for regular zero point acquisition, while leaving the measurement sample set as it is.

The present disclosure provides a spectroscopic analysis apparatus that includes:
a light source configured to emit light comprising at least a first wavelength and a second wavelength;
a spectrometer configured to separate light emitted from the light source into light of the first wavelength and light of the second wavelength;
a detector configured to detect light of the first wavelength and light of the second wavelength that are emitted from the spectrometer and pass through a sample; and
a controller configured to calculate first absorbance of the sample corresponding to light of the first wavelength and second absorbance of the sample corresponding to light of the second wavelength based on a detection result of the detector,
wherein the controller calculates post-correction absorbance of the sample corresponding to light of the first wavelength by correcting the first absorbance using the second absorbance.

The present disclosure provides a spectroscopic analysis method that includes:
emitting light comprising at least a first wavelength and a second wavelength from a light source;
separating the light emitted from the light source into light of a first wavelength and light of a second wavelength;
detecting light of the first wavelength and light of the second wavelength that pass through a sample;
calculating first absorbance of the sample corresponding to light of the first wavelength and second absorbance of the sample corresponding to light of the second wavelength based on a detection result; and
calculating post-correction absorbance of the sample corresponding to light of the first wavelength by correcting the first absorbance using the second absorbance.

The present disclosure provides a spectroscopic analysis program configured to cause a computer to execute:
a process of emitting light comprising at least a first wavelength and a second wavelength from a light source;
a process of separating the light emitted from the light source into light of a first wavelength and light of a second wavelength;
a process of detecting light of the first wavelength and light of the second wavelength that pass through a sample;
a process of calculating first absorbance of the sample corresponding to light of the first wavelength and second absorbance of the sample corresponding to light of the second wavelength based on a detection result; and
a process of calculating post-correction absorbance of the sample corresponding to light of the first wavelength by correcting the first absorbance using the second absorbance.

According to the present disclosure, even though measuring the absorbance at a specific wavelength for a sample over a long period of time, it is possible to measure correct absorbance by performing zero point calibration by correcting the first absorbance at the specific wavelength using the second absorbance at another wavelength.

### BRIEF DESCRIPTION OF THE DRAWINGS

FIG. 1 is a block diagram of a spectroscopic analysis apparatus according to an embodiment of the present disclosure;

FIG. 2 is an example of an absorption spectrum graph of a sample;

FIG. 3 is a graph showing the change in first absorbance over time of light at a dominant wavelength;

FIG. 4 is a graph showing the change in first absorbance over time of light at a secondary wavelength;

FIG. 5 is a graph showing the change in absorbance over time after correction of light at the dominant wavelength; and

FIG. 6 is a flowchart showing the sequence of performing a spectroscopic analysis method using a spectroscopic analysis apparatus.

### DETAILED DESCRIPTION

Hereafter, exemplary embodiments of a spectroscopic analysis apparatus according to the present disclosure are described in detail with reference to the drawings.

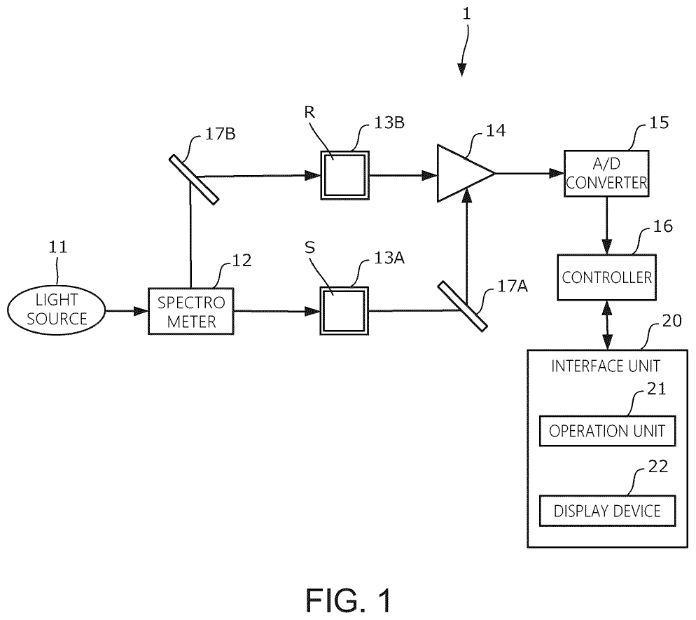

FIG. 1 is a block diagram of a spectroscopic analysis apparatus according to an embodiment of the present disclosure. A spectroscopic analysis apparatus 1 of this embodiment is, for example, a spectrophotometer that measures the transmittance or absorbance of a sample by emitting light to the sample and detecting light that pass through the sample. The spectroscopic analysis apparatus 1 includes a light source 11, a spectrometer 12, a sample cell 13A, a reference sample cell 13B, a detector 14, an A/D converter 15, a controller 16, a mirror 17A, a mirror 17B, and an interface unit 20.

The light source 11 emits light that includes at least a dominant wavelength (first wavelength) and a secondary wavelength (second wavelength) to be described below. The light source 11, for example, can emit white light, which is a mixture of light of different wavelengths, and is composed of a gas discharge lamp, a Light Emitting Diode (LED), a laser, etc.

The spectrometer 12 spectrally separates light of specific wavelengths, that is, in this case, light at a dominant wavelength light and light at a secondary wavelength from light incident from the light source 11, and emits the spectrally separated light to the sample cell 13A and the reference sample cell 13B. The spectrometer 12 is equipped with a diffraction grating, and can extract light of various wavelengths by changing the angle of the diffraction grating at fixed intervals of unit time.

The sample cell 13A accommodates a sample S that is a measurement object. The sample S is, for example, a liquid, and the sample cell 13A is a box-shaped container that can accommodate this liquid. The reference sample cell 13B accommodates a reference sample R (air, blank solution, reference sample, or the like) and has the same configuration as the sample cell 13A.

The detector 14 detects light of the dominant wavelength and light of the secondary wavelength that pass through the sample S in the sample cell 13A, and at the same time, detects light of the dominant wavelength and light of the secondary wavelength that pass through the reference sample R in the reference sample cell 13B. Meanwhile, the light of the dominant wavelength and the light of the secondary wavelength that pass through the sample cell 13A are reflected by the mirror 17A and reach the detector 14, and the light of the dominant wavelength and the light of the secondary wavelength that have been separated by the spectroscope 12 are reflected by the mirror 17B and reach the reference sample cell 13B.

The A/D converter 15 converts analog data values (analog intensity of light of the dominant wavelength and analog intensity of light of the secondary wavelength) output by the detector 14 into digital data values. The controller 16, which is a processor that oversees the entire operation of the spectroscopic analysis apparatus 1, includes an input/output unit that performs input and output of data, a memory unit that stores data, predetermined programs, and etc. The controller 16 reads the program stored in the memory unit and executes the steps of the processing to be described below, and also performs various calculations.

The interface unit 20, which is a device through which the user of the spectroscopic analysis apparatus 1 performs operation input of the spectroscopic analysis apparatus 1 and simultaneously observes the processing result, includes an operation unit 21 and a display device 22. The operation unit 21, which is a device through which an operator inputs input signals required for the processing of the control unit 16, includes a keyboard, a mouse, a touch panel, etc. The display device 22 displays various analysis results processed by the controller 16.

The zero point (origin) of the incident light amount in the measurement of the spectroscopic analysis apparatus can vary due to various factors such as changes in the characteristics of the spectroscopic analysis apparatus and changes in the surrounding environment, so it is required to regularly perform zero point calibration. For example, unlike the spectroscopic analysis apparatus 1 of FIG. 1, in the case of a single beam-type spectroscopic analysis apparatus, which does not use a reference sample R, it is common to remove a sample and measure a reference sample while exchanging the sample that is a measurement object, and perform zero point calibration using the measurement result of the reference sample. However, when it is required to continuously measure a measurement sample, such as monitoring the measurement sample over a long period of time, it may not be possible to replace the measurement sample with a reference sample for measurement in some cases.

Meanwhile, the spectroscopic analysis apparatus 1 of FIG. 1 is a double beam-type apparatus that performs measurement not only on a sample S that is a measurement object but also on a reference sample R in parallel, and can perform zero point calibration based on the measurement result of the reference sample R.

However, the double beam-type spectroscopic analysis apparatus 1 has two mirrors 17A and 17B that reflect light. Typically, the installation positions of mirrors are different due to their relative positional relationships with other components, and the optical path passing through the sample cell 13A and the mirror 17A and reaching the detector 14 from the spectrometer 12, and the optical path passing through mirror 17B and the reference sample cell 13B and reaching the detector 14 from the spectrometer 12 do not take a symmetrical structure. The asymmetry of the two optical paths as described above becomes a factor that increases measurement deviation between the two optical paths during long-term measurement, which may make it difficult to perform accurate measurement.

Therefore, the spectroscopic analysis apparatus 1 according to an embodiment measures the absorbance of light at the wavelength (dominant wavelength, first wavelength) at which the original absorbance of a sample is desired as first absorbance, and simultaneously measures the absorbance of light at another wavelength (secondary wavelength, second wavelength) as second absorbance. Further, the spectroscopic analysis apparatus 1 calculates post-correction absorbance of a sample corresponding to light at the wavelength originally desired by correcting the first absorbance using the second absorbance. Accordingly, the spectroscopic analysis apparatus 1 according to an embodiment can measure correct absorbance by performing zero point calibration by correcting the first absorbance at a specific wavelength using the second absorbance at another wavelength, even though it measures the absorbance at the specific wavelength over a long time. Hereafter, processing by the spectroscopic analysis apparatus 1 is described in detail.

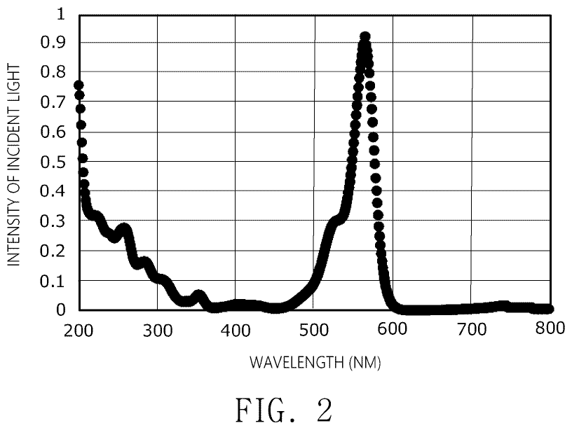

First, a user drives the spectroscopic analysis apparatus 1 to measure the absorption spectrum of a sample S. FIG. 2 is a graph showing an example of the absorption spectrum of a sample, in which the absorption spectrum represents the absorbance in a specific wavelength range (for example, 200 nm to 800 nm). The absorption spectrum of FIG. 2 can be obtained by changing the absorbance at each wavelength by changing the wavelength taken by the spectrometer 12 altering the angle of the diffraction grating while light is emitted from the light source 11. Measurement of an absorption spectrum is performed when a specific sample is measured for the first time, and can be omitted for subsequent measurements of the same. The display device 22 may display the graph of FIG. 2.

Next, the user can set an absorption wavelength at which an absorbance is to be obtained, that is, a dominant wavelength (first wavelength) with reference to the obtained absorption spectrum, and input the dominant wavelength through the operation unit 21. The dominant wavelength does not necessarily have to be a peak (peak top) of the absorption spectrum, and is a wavelength at which the user wants to focus analysis. Meanwhile, the controller 16 may automatically determine a dominant wavelength based on an absorption spectrum. The controller 16 may, for example, automatically determine a dominant wavelength by using the wavelength of a peak of an absorption spectrum as the dominant wavelength.

Next, the user can set a non-absorption wavelength, that is, a secondary wavelength (second wavelength) with reference to the obtained absorption spectrum, and input the secondary wavelength through the operation unit 21. Searching for a non-absorption wavelength involves selecting any one of a shorter wavelength or a longer wavelength from a dominant wavelength, and the wavelength representing absorbance below a predetermined threshold value is considered as a non-absorption wavelength. In particular, the user can select a wavelength representing absorbance closest to 0. However, absorbance may be a value less than or equal to 0 (negative). Further, a user may freely determine absorbance in consideration of the characteristics of a sample S. Meanwhile, the controller 16 may automatically determine a secondary wavelength based on an absorption spectrum. The controller 16, for example, may automatically determine a wavelength representing absorbance closest to 0 as a secondary wavelength.

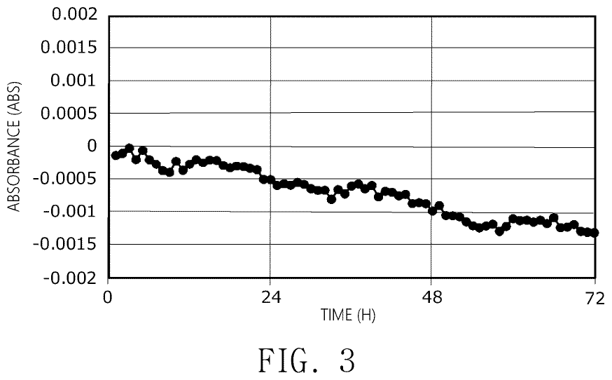

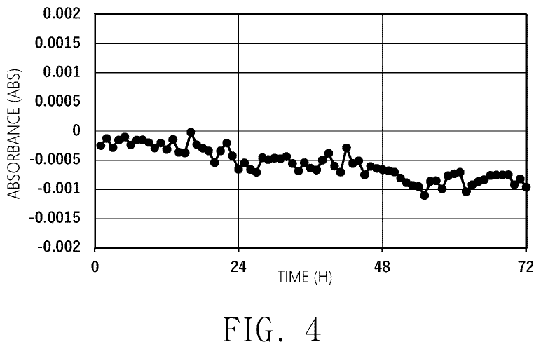

As a result of the above process, when the controller 16 obtains a dominant wavelength and a secondary wavelength, the spectroscopic analysis apparatus 1 starts a detailed search for the absorbance corresponding to light of the dominant wavelength and the secondary wavelength. The spectroscopic analysis apparatus 1 first continuously measures the absorbance corresponding to light of the dominant wavelength for the sample S over a predetermined time. The controller 16 calculates first absorbance of the sample S corresponding to the light of the dominant wavelength based on the detection result from the detector 14. As a result, a graph showing change of the first absorbance over time for the light of the dominant wavelength is obtained, as shown in FIG. 3. Meanwhile, the values in FIG. 3 (the vertical axis) represent the values obtained by subtracting 0.9 from the absorbance obtained from wavelengths around 560 nm of FIG. 2 in order to clearly show the effect of correction based on the values in FIG. 4 to be described below. The following description refers to the actual absorbance values.

Further, the spectroscopic analysis apparatus 1 continuously measures the absorbance corresponding to light of the secondary wavelength for the sample S. The controller 16 calculates second absorbance of the sample S corresponding to the light of the secondary wavelength based on the detection result from the detector 14. As a result, a graph showing change in the second absorbance over time for the light of the secondary wavelength is obtained, as shown in FIG. 4. FIG. 3 and FIG. 4 show change in absorbance up to 72 hours.

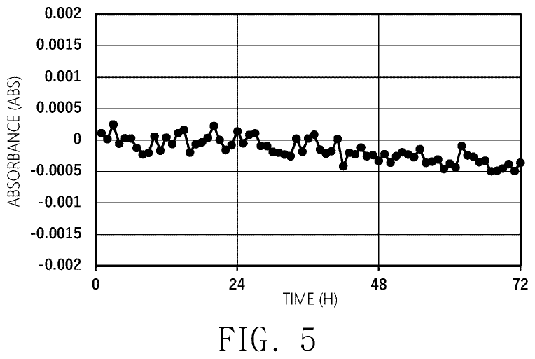

When the values shown in FIG. 3 and FIG. 4 are obtained, the controller 16 calculates post-correction absorbance of the sample S corresponding to the light of the dominant wavelength by correcting the first absorbance of FIG. 3 using the second absorbance of FIG. 4. As a result, as shown in FIG. 5, it is possible to calculate absorbance over time after correction from the light of the dominant wavelength.

The controller 16, in detail, can calculate the absorbance shown in FIG. 5 by subtracting the second absorbance of FIG. 4 from the first absorbance of FIG. 3. That is, the correction formula is: post-correction absorbance of dominant wavelength=first absorbance of dominant wavelength-second absorbance of secondary wavelength. Accordingly, it is possible to easily calculate the absorbance of the sample by correcting the first absorbance. Meanwhile, the values (the vertical axis) in FIG. 5, similar to FIG. 3, represent values obtained by subtracting 0.9 from actually obtained absorbance. The graph in FIG. 5, unlike the uncorrected graph of the first absorbance in FIG. 3, shows change in the actual absorbance of after correction, so the user can accurately observe correct change in absorbance.

The spectroscopic analysis apparatus 1 of this embodiment can calculate post-correction absorbance of the sample S corresponding to the dominant wavelength by correcting the first absorbance corresponding to the dominant wavelength using the second absorbance corresponding to the secondary wavelength. Accordingly, even though the absorbance at a specific wavelength such as the dominant wavelength is measured over a long time for the sample S, it is possible to measure correct absorbance by performing zero point calibration by correcting the first absorbance at the specific wavelength using the second absorbance at another wavelength such as the secondary wavelength.

In particular, the secondary wavelength can be determined as a wavelength at which the second absorbance is closest to 0 (zero). A user may also set the wavelength at which absorbance represents a value closest to 0 in the absorption spectrum of FIG. 2 as a secondary wavelength. The controller 16, similarly, may automatically set a secondary wavelength.

Light of the wavelength at which absorbance represents a value closest to 0 is hardly absorbed by the sample S, so it is considered that the correlation with the variation in concentration of the sample over time is low. That is, it is considered that such variation in light is caused by variation in the characteristics of the spectroscopic analysis apparatus 1 and/or environmental variation, the amount of light before passing through the sample changes, and this variation is associated with the change in the first absorbance. Accordingly, by selecting a wavelength at which the second absorbance represents a value closest to 0 as the wavelength of the second absorbance for correcting the first absorbance, zero point calibration can be accurately performed, whereby correct absorbance can be obtained.

As described above, the controller 16 can determine a dominant wavelength and a secondary wavelength based on the absorption spectrum of FIG. 2 acquired in advance. Accordingly, it is possible to automatically determine a dominant wavelength and a secondary wavelength, so it is possible to reduce the user's burden. Of course, this does not prevent a user from determining a dominant wavelength and a secondary wavelength by himself/herself.

The spectroscopic analysis apparatus 1 of this embodiment, as shown in FIG. 3 and FIG. 4, continuously acquires first absorbance and second absorbance by continuously detecting light of the dominant wavelength and light of the secondary wavelength. Accordingly, it is possible to continuously measure the absorbance of the sample S.

However, the spectroscopic analysis apparatus 1 may continuously acquire first absorbance by continuously detecting light of the dominant wavelength and periodically acquire second absorbance by periodically detecting light of the secondary wavelength. This is because the second absorbance is a value for correcting the first absorbance and is not originally intended to be acquired. Accordingly, it is possible to reduce the processing related to calculation of the second absorbance by the controller 16 and continuously measure the absorbance of the sample S. The periodical acquisition refers to, for example, acquisition every 24 hours, but the time interval is not specifically limited.

Further, the controller may estimate the rate of change of second absorbance based on the change in the second absorbance over a predetermined time, and correct first absorbance using the rate of change. For example, the controller 16 directly acquires second absorbance during a first period and calculates a slope corresponding to change in the second absorbance during the first period. Further, the controller 16 may calculate second absorbance during a second period using the calculated slope without directly acquiring the second absorbance during the second period after the first period. Accordingly, it is possible to reduce the processing related to calculation of the second absorbance by the controller 16 and continuously measure the absorbance of the sample S.

As described above, the spectroscopic analysis apparatus 1 of this embodiment adopts the so-called double beam type, in which light is emitted on both the sample cell 13A and the reference sample cell 13B, so the spectrometer 12 emits light of a dominant wavelength and a secondary wavelength to the reference sample R in the reference sample cell 13B as well. The detector 14 detects the light of the dominant wavelength and the light of the secondary wavelength that pass through the reference sample R. Accordingly, the controller 16 can calculate the first absorbance of the reference sample R corresponding to the light of the dominant wavelength and the second absorbance of the reference sample R corresponding to the light of the secondary wavelength based on the detection result of the detector 14.

Accordingly, the spectroscopic analysis apparatus 1 performs the same processing on the reference sample R as the sample S that is a measurement object, so it is possible to increase precision in measurement by performing calculation on the reference sample R as well.

Meanwhile, the spectroscopic analysis apparatus 1 of this embodiment adopts a double beam type, but the processing of the present disclosure may also be applied to so-called single beam-type spectroscopic analysis apparatuses, and the reference sample cell 13B is not necessary.

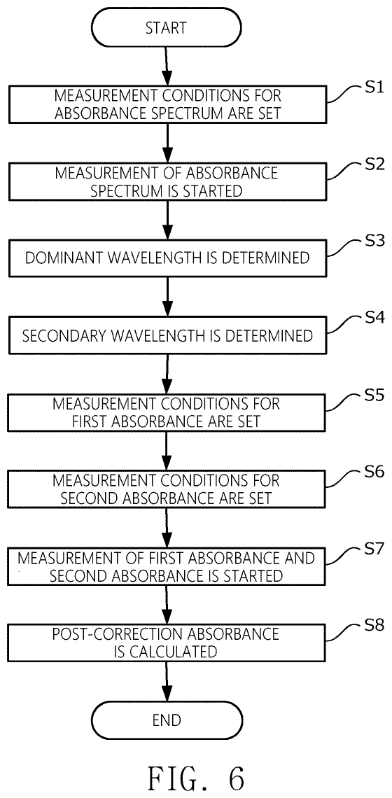

FIG. 6 is a flowchart showing the sequence of performing a spectroscopic analysis method using the spectroscopic analysis apparatus 1 of this embodiment. In this description, measurement of the reference sample R in the reference sample cell 13B is omitted. A user sets conditions for measuring an absorbance spectrum of a sample by operating the operation unit 21 (step S1). The conditions in this case may include a measurement mode of an absorbance spectrum, a wavelength band for measuring absorbance, etc. After setting the conditions, when the user instructs to start measurement of an absorption spectrum by operating the operation unit 21, the spectroscopic analysis apparatus 1 starts measurement of the absorption spectrum (step S2).

After the measurement of the absorption spectrum, as shown in FIG. 2, is finished, the user checks the absorption spectrum displayed on the display device 22 and determines a dominant wavelength (step S3). The controller 16 may automatically determine the dominant wavelength based on the absorption spectrum. Next, the user checks the absorption spectrum displayed on the display device 22 and determines a secondary wavelength (step S4). The controller 16 may automatically determine the secondary wavelength based on the absorption spectrum.

Next, the user sets measurement conditions for first absorbance at the dominant wavelength by operating the operation unit 21 (step S5). The measurement conditions in this case include a measurement mode of the first absorbance, time for which the first absorbance is measured, etc. Further, the user sets measurement conditions for second absorbance at the secondary wavelength by operating the operation unit 21 (step S6). The measurement conditions in this case include a measurement mode of the second absorbance, time for which the second absorbance is measured, etc.

After finishing setting the measurement conditions, when the user instructs to start measurement of the first absorbance and the second absorbance by operating the operation unit 21, the spectroscopic analysis apparatus 1 starts measurement of the first absorbance and the second absorbance. When the measurement of the first and second absorbance is finished, as shown in FIG. 3 and FIG. 4, the controller 16 calculates final post-correction absorbance by correcting the first absorbance by subtracting the second absorbance from the first absorbance (step S8).

The features of the embodiment of the spectroscopic analysis apparatus, spectroscopic analysis method, and spectroscopic analysis program according to the present disclosure described above are summarized and listed concisely below as [1] to [10].

[1] Provided is a spectroscopic analysis apparatus (spectroscopic analysis apparatus 1) that includes:
a light source (light source 11) emitting light comprising at least a first wavelength and a second wavelength;
a spectrometer (spectrometer 12) spectrally separating the light emitted from the light source into light of the first wavelength and light of the second wavelength;
a detector (detector 14) detecting light of the first wavelength and light of the second wavelength that are emitted from the spectrometer and pass through a sample; and
a controller (controller 16) calculating first absorbance of the sample corresponding to light of the first wavelength and second absorbance of the sample corresponding to light of the second wavelength based on a detection result of the detector,
wherein the controller calculates post-correction absorbance of the sample corresponding to light of the first wavelength by correcting the first absorbance using the second absorbance.

Accordingly, even though measuring the absorbance at a specific wavelength for a sample over a long time, it is possible to measure correct absorbance by performing zero point calibration by correcting the first absorbance at the specific wavelength using the second absorbance at another wavelength.

[2] In the spectroscopic analysis apparatus described in [1], the controller calculates the post-correction absorbance by subtracting the second absorbance from the first absorbance.

Accordingly, it is possible to easily calculate the absorbance of the sample by correcting the first absorbance.

[3] In the spectroscopic analysis apparatus described in [2], the second wavelength is a wavelength at which the second absorbance is closest to 0.

Light of the wavelength at which absorbance represents a value closest to 0 is hardly absorbed by a sample, so it is considered that the correlation with the variation in concentration of the sample over time is low. That is, it is considered that such variation in light is caused by variation in the characteristics of the spectroscopic analysis apparatus and/or environmental variation, the amount of light before passing through the sample changes, and this variation is associated with the change in the first absorbance. Accordingly, by selecting a wavelength at which the second absorbance represents a value closest to 0 as the wavelength of the second absorbance for correcting the first absorbance, zero point calibration can be accurately performed, whereby correct absorbance can be obtained.

[4] In the spectroscopic analysis apparatus described in [1], the controller determines the first wavelength and the second wavelength based on an absorbance spectrum of the sample acquired in advance.

Accordingly, it is possible to automatically determine the first wavelength and the second wavelength, so it is possible to reduce the user's burden.

[5] In the spectroscopic analysis apparatus described in [1], the first absorbance and the second absorbance are continuously acquired.

Accordingly, it is possible to continuously measure the absorbance of the sample.

[6] In the spectroscopic analysis apparatus described in [1], the first absorbance is continuously acquired and the second absorbance is periodically acquired.

Accordingly, it is possible to reduce the processing related to calculation of the second absorbance and continuously measure the absorbance of the sample.

[7] In the spectroscopic analysis apparatus described in [1], the controller estimates the rate of change of the second absorbance based on change in the second absorbance over a predetermined time and corrects the first absorbance using the rate of change.

Accordingly, it is possible to reduce the processing related to calculation of the second absorbance and continuously measure the absorbance of the sample.

[8] In the spectroscopic analysis apparatus described in [1], the spectrometer emits light of the first wavelength and light of the second wavelength to a reference sample, and the detector detects light of the first wavelength and light of the second wavelength that pass through the reference sample; and
the controller calculates first absorbance of the reference sample corresponding to light of the first wavelength and second absorbance of the reference sample corresponding to light of the second wavelength based on a detection result of the detector.

Accordingly, since the same processing as the sample that is a measurement sample is performed on the reference sample, it is possible to increase precision in measurement by continuously performing calculation on the reference sample as well.

[9] Provided is a spectroscopic analysis method that includes:
emitting light comprising at least a first wavelength and a second wavelength from a light source;
spectrally separating the light emitted from the light source into light of a first wavelength and light of a second wavelength;
detecting light of the first wavelength and light of the second wavelength that pass through a sample;
calculating first absorbance of the sample corresponding to light of the first wavelength and second absorbance of the sample corresponding to light of the second wavelength based on a detection result; and
calculating post-correction absorbance of the sample corresponding to the light of the first wavelength by correcting the first absorbance using the second absorbance.

Accordingly, even though measuring the absorbance at a specific wavelength for a sample over a long time, it is possible to measure correct absorbance by performing zero point calibration by correcting the first absorbance at the specific wavelength using the second absorbance at another wavelength.

[10] Provided is a spectroscopic analysis program configured to cause a computer to execute:
a process of emitting light comprising at least a first wavelength and a second wavelength from a light source;
a process of separating the light emitted from the light source into light of a first wavelength and light of a second wavelength;
a process of detecting light of the first wavelength and light of the second wavelength that pass through a sample;
a process of calculating first absorbance of the sample corresponding to light of the first wavelength and second absorbance of the sample corresponding to light of the second wavelength based on a detection result; and
a process of calculating post-correction absorbance of the sample corresponding to light of the first wavelength by correcting the first absorbance using the second absorbance.

Accordingly, even though measuring the absorbance at a specific wavelength for a sample over a long time, it is possible to measure correct absorbance by performing zero point calibration by correcting the first absorbance at the specific wavelength using the second absorbance at another wavelength.

Meanwhile, the present disclosure is not limited to the embodiments described above and can be appropriately modified or improved. In addition, the materials, shapes, dimensions, values, forms, numbers, and arrangement positions of components in the embodiments described above are arbitrary as long as the present disclosure can be achieved, and are not limited thereto.

The present disclosure is useful in the field of spectroscopic analysis performed over a long time.

What is claimed is:

1. A spectroscopic analysis apparatus comprising:
a light source configured to emit light comprising at least a first wavelength and a second wavelength;
a spectrometer configured to separate light emitted from the light source into light of the first wavelength and light of the second wavelength;
a detector configured to detect light of the first wavelength and light of the second wavelength that are emitted from the spectrometer and pass through a sample; and
a controller configured to calculate first absorbance of the sample corresponding to light of the first wavelength and second absorbance of the sample corresponding to light of the second wavelength based on a detection result of the detector,
wherein the controller calculates post-correction absorbance of the sample corresponding to light of the first wavelength by correcting the first absorbance using the second absorbance.

2. The spectroscopic analysis apparatus according to claim 1, wherein the controller calculates the post-correction absorbance by subtracting the second absorbance from the first absorbance.

3. The spectroscopic analysis apparatus according to claim 2, wherein the second wavelength is a wavelength at which the second absorbance is closest to 0.

4. The spectroscopic analysis apparatus according to claim 1, wherein the controller determines the first wavelength and the second wavelength based on an absorbance spectrum of the sample acquired in advance.

5. The spectroscopic analysis apparatus according to claim 1, wherein the first absorbance and the second absorbance are continuously acquired.

6. The spectroscopic analysis apparatus according to claim 1, wherein the first absorbance is continuously acquired and the second absorbance is periodically acquired.

7. The spectroscopic analysis apparatus according to claim 1, wherein the controller estimates a rate of change of the second absorbance based on a change in the second absorbance over a predetermined time and corrects the first absorbance using the rate of change.

8. The spectroscopic analysis apparatus according to claim 1, wherein the spectrometer emits the light of the first wavelength and light of the second wavelength to a reference sample, and
the detector detects light of the first wavelength and light of the second wavelength that pass through the reference sample, and
the controller calculates first absorbance of the reference sample corresponding to light of the first wavelength and second absorbance of the reference sample corresponding to light of the second wavelength based on a detection result of the detector.

9. A spectroscopic analysis method comprising:
emitting light comprising at least a first wavelength and a second wavelength from a light source;
separating the light emitted from the light source into light of a first wavelength and light of a second wavelength;
detecting light of the first wavelength and light of the second wavelength that pass through a sample;
calculating first absorbance of the sample corresponding to light of the first wavelength and second absorbance of the sample corresponding to light of the second wavelength based on a detection result; and
calculating post-correction absorbance of the sample corresponding to light of the first wavelength by correcting the first absorbance using the second absorbance.

10. A spectroscopic analysis program configured to cause a computer to execute:
a process of emitting light comprising at least a first wavelength and a second wavelength from a light source;
a process of separating light emitted from the light source into light of a first wavelength and light of a second wavelength;
a process of detecting light of the first wavelength and light of the second wavelength that pass through a sample;
a process of calculating first absorbance of the sample corresponding to light of the first wavelength and second absorbance of the sample corresponding to light of the second wavelength based on a detection result; and
a process of calculating post-correction absorbance of the sample corresponding to light of the first wavelength by correcting the first absorbance using the second absorbance.
